(19) United States
(12) Patent Application Publication
(10) Pub. No.: US 2011/0184842 A1
(43) Pub. Date: Jul. 28, 2011

(54) ENERGY TRANSFER SYSTEMS AND METHODS FOR MOBILE VEHICLES

(76) Inventor: Roger D Melen, Los Altos Hills, CA (US)

(21) Appl. No.: 12/695,700

(22) Filed: Jan. 28, 2010

(51) Int. Cl. H02J 7/02; G06F 1/26; G06F 7/04; G01C 21/26; G06Q 30/00

(52) U.S. Cl. 705/34; 320/108; 700/295; 340/5.2; 701/207; 701/22

(57) ABSTRACT

An energy transfer system comprises a transmitter array, an energy transfer controller, a receiver array, a charging module. The transmitter array is embedded in a roadway and the energy transfer controller is coupled to the transmitter array. The receiver array and the charging module are part of a mobile vehicle. The transmitter array and the receiver array each include a plurality of coils. The energy transfer controller estimates a likely trajectory of the mobile vehicle and energizes individual coils of the transmitter array using this position estimate. The energy transfer controller varies the resonant circuit component values of the transmitter during the transfer cycle such as resonant coupling capacitance values. The charging module also varies the resonant circuit component values of the coils in the receiver array to match the transfer array for transfer of energy from the transmitter array to the receiver array. The present invention also includes a method for energy transfer.

### BACKGROUND OF THE INVENTION

1. Field of the Invention

This invention relates to systems and methods for transferring energy. In particular, the present invention relates to system and method for transferring energy from a roadway to a moving vehicle.

The terms roadway and vehicle are taken broadly. Alternatively, the two components may be a pathway and a moving electricity-powered system. The invention may be used as part of a smaller system designed for indoor use where the roadway or path may be called a floor or a raceway and the vehicle may be a cart or a scooter or forklift truck.

2. Description of the Background Art

As fossil fuel becomes a remnant of the past, alternative energy sources usher in a new era of harnessing, storing and utilizing energy. In particular in the context of motor vehicles, engines once driven by the burning of gasoline are being replaced with engines that run on electricity stored in batteries in the vehicle. While this solves problems like pollution in particular, carbon emissions, it creates other new problems.

One such challenge is filling or charging an energy source such as a battery for later use. Presently, to charge an energy source, one needs to find an energy transfer center, suspend what they were doing and stop for the energy transfer. One particular problem is that to recharge the power source of an electric vehicle often requires two if not more hours. One example of such an energy transfer center is service stations that present sell and dispense gasoline. However, for most existing service stations do not have enough parking areas for the vehicles while they are being recharged.

Many fully electric vehicles are recharged in garages where they are stored when not in use. For example, a power outlet in a wall is used to plug in and recharge the energy storage. While this is acceptable for vehicles that are used only for commuting, this limits their usefulness when traveling over longer distances. This often limits the usefulness of fully electric vehicles to less than 100 miles.

There have been attempts to transfer energy to vehicles while they are moving, but such efforts have not been effective. Once particular, problem is that vehicles travel quickly over transfer coils. High vehicle speeds result in small values for transfer times. This has prevented existing system to effectively transfer energy to moving vehicles. Furthermore, while there have also been attempts to create energy transfer centers that employ methods that work well for stationary objects, a moving object cannot be recharged by such methods.

The potential use of electric systems for temporary energy storage applications is comprehensively described in “Electric Vehicles as a New Source of Power for Electric Utilities” by W. Kempton and Steven Letendre, 1997, Transportation Research 2(3), pp. 157-175.

### SUMMARY OF THE INVENTION

The present invention overcomes the problems of the prior art with energy transfer systems for mobile vehicles. The system of the present invention comprises a transmitter array, an energy transfer controller, a receiver array, and a charging module. In one embodiment, the transmitter array is embedded in a roadway and the energy transfer controller is coupled to the transmitter array positioned proximate the roadway. The receiver array and the charging module are part of a mobile vehicle such as an electric car. The transmitter array and the receiver array each include a plurality of coils. The energy transfer controller estimates a likely trajectory of the mobile vehicle and energizes individual coils of the transmitter array using this position estimate. The energy transfer controller varies the resonant circuit component values of the transmitter during the transfer cycle such as resonant coupling capacitance values. The charging module also varies the resonant circuit component values of the coils in the receiver array to match the transfer array for transfer of energy from the transmitter array to the receiver array. Transfer frequency or coil resonant frequency (inductance or capacitance) is adjusted at both transmitter array and the receiver array to achieve maximum transfer efficiency in different weather and road conditions. Best tuning varies with many factors including coil coupling coefficient. Coupling coefficient are varied using models estimating the precise vehicle position on roadway. Real-time adjustment of resonance components includes vehicle position data to boost transfer efficiency. The present invention also includes a method for energy transfer.

Note that in the above system, the transmitter array is described as being located in the roadway and the receiver is located in the vehicle. Other embodiments may include a transmitter array in the vehicle and the receiving array in the roadway. It also possible that the roadway and vehicle includes both a transmitter array and receiver array permitting energy transfer in either direction under the control of the energy transfer controller. Certain transmit and receive components such as inductive coils may be used for bidirectional transmit and receive operations in the vehicle and in the roadway to save space as well as cost. The bidirectional transfer of energy may be used to routinely supply electric energy to the vehicle, and occasionally to provide energy from the vehicle to the roadway.

### BRIEF DESCRIPTION OF THE DRAWINGS

The invention is illustrated by way of example, and not by way of limitation in the figures of the accompanying drawings.

FIG. 1 is a block diagram illustrating an energy transfer system according to one embodiment of the present invention.

FIG. 2 is a block diagram illustrating the energy transfer system according to another embodiment of the present invention.

FIG. 3 is a block diagram illustrating a mobile vehicle including a receiver array, charging module and an energy storage unit according to one embodiment of the present invention.

FIG. 4A is a block diagram illustrating a transmitter array according to one embodiment of the present invention.

FIG. 4B is a block diagram illustrating the transmitter array according to a second embodiment of the present invention.

FIG. 4C is a block diagram illustrating the transmitter array according to a third embodiment of the present invention.

FIG. 5A is a block diagram illustrating a mobile vehicle, a transmitter array and various trajectories according to one embodiment of the present invention.

FIG. 5B-5D are block diagrams illustrating a transmitter array, a receiver array and various trajectories according to a first embodiment of the present invention.

FIG. 6 is a block diagram illustrating a coil and its circuitry for a transmitter array and a corresponding coil and its circuitry for a receiver array according to one embodiment of the present invention.

FIG. 7 is a block diagram illustrating a coil and its circuitry for the transmitter array and a corresponding coil and its circuitry for the receiver array according to a second embodiment of the present invention.

FIG. 8 is a block diagram illustrating a charging module for a mobile vehicle according to one embodiment of the present invention.

FIG. 9 is a block diagram illustrating an energy transfer controller according to one embodiment of the present invention.

FIG. 10 is a block diagram illustrating a charging controller of the energy transfer controller according to one embodiment of the present invention.

FIGS. 11A and 11B are a flow chart illustrating a method for energy transfer according to one embodiment of the invention.

The figures depict various embodiments of the present invention for purposes of illustration only. It is noted that wherever practicable similar or like reference numbers may be used in the figures and may indicate similar or like functionality. One skilled in the art will readily recognize from the following discussion that alternative embodiments of the structures and methods illustrated herein may be employed without departing from the principles of the invention described herein.

### DETAILED DESCRIPTION

Systems and methods for transferring energy to mobile systems, in particular vehicles, are disclosed. A mobile vehicle with an energy storage unit approaches an energy transfer zone. The energy transfer controller detects the approaching mobile vehicle and calculates the predicted trajectory for mobile vehicle. As the mobile vehicle moves across a transmitter array in an energy transfer zone, the energy transfer controller calibrates itself to efficiently transfer energy to the mobile vehicle. The mobile vehicle need not come to a halt, and the operator of the mobile vehicle does not need to plug the mobile vehicle into an outlet for the energy transfer. Thus energy transfer to the mobile vehicle is seamless and automatic, and the mobile vehicle operator does not need to take any action.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements but may include other elements not expressly listed or inherent to such process, method, article or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Some portions of the detailed descriptions that follow are presented in terms of algorithms and symbolic representations of operations on data bits within a computer memory. These algorithmic descriptions and representations are the means used by those skilled in the electrical arts to most effectively convey the substance of their work to others skilled in the art. An algorithm is here, and generally, conceived to be a self-consistent sequence of steps leading to a desired result. The steps are those requiring physical transformations or manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose computing systems including a processor, memory, non-volatile storage, input device and output device may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

### Energy Transfer System 100, 200

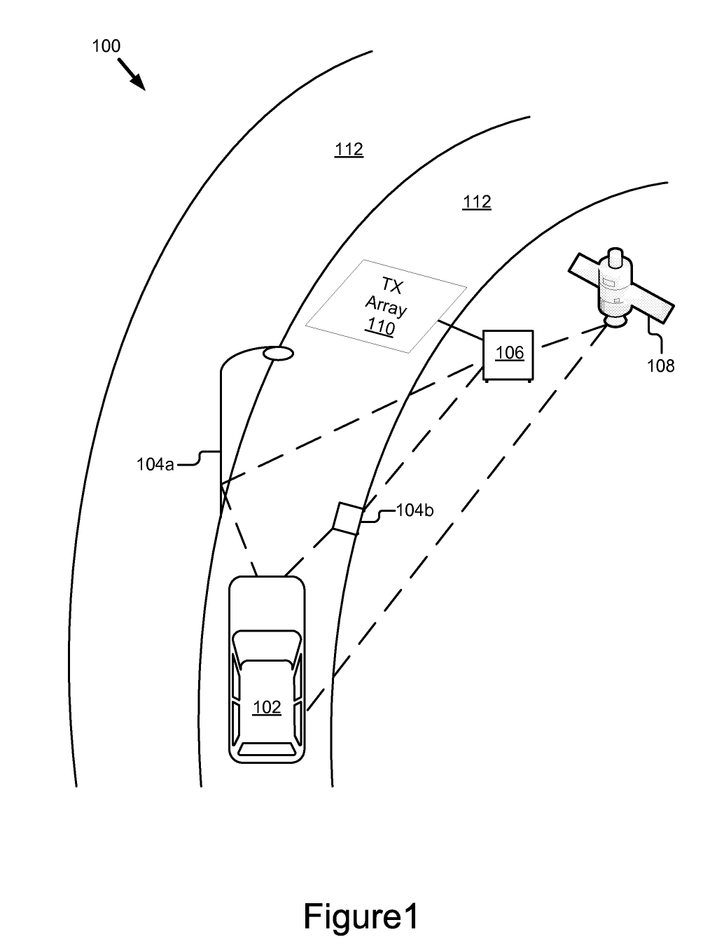

Referring now to FIG. 1, a first embodiment of an energy transfer system 100 is shown. The energy transfer system 100 includes a mobile vehicle 102, one or more location sensors 104a, 104b, an energy transfer controller 106, optionally a global positioning system 108 and a transmitter array 110. In this embodiment, consistent with the principles of the present invention, an energy transfer system 100 is located along a curved road way 112. The energy transfer system 100 is preferably deployed at locations where the mobile vehicle 102 has reduced speed. In particular, the reduced speed of the mobile vehicle 102 translates into a greater transfer time which means more energy transferred per coil and fewer coils required transfers per mile.

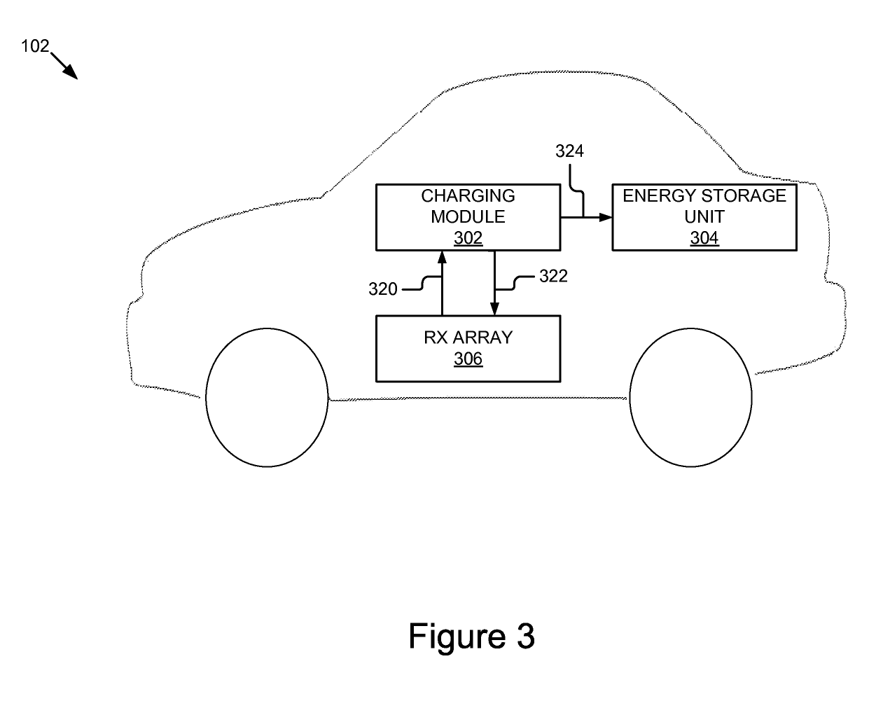

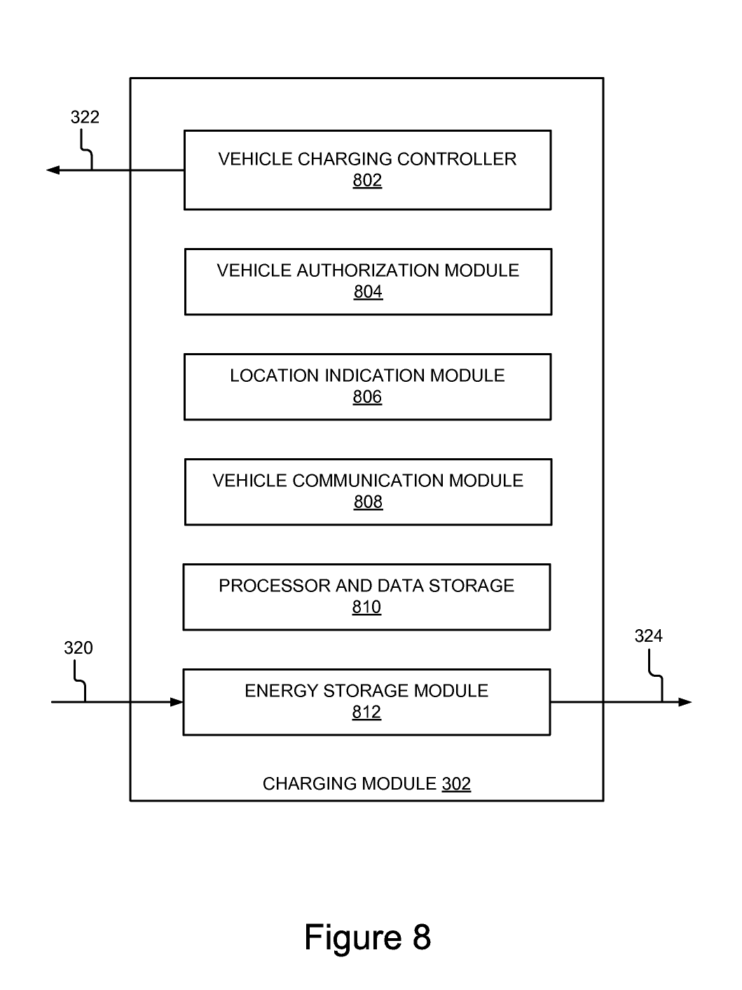

The mobile vehicle 102 is any type of vehicle that requires electrical power. The mobile vehicle 102 includes various other electrical, mechanical and communications systems available on various hybrid and fully electric vehicles such as the Prius automobile manufactured and sold by Toyota Motor Company. While the present invention will now be describe in the context of electric and hybrid cars, those skilled in the art will recognize that the present invention may also be use to transfer energy to other mobile devices such as but not limited to cell phones, portable electronics, robots wheel chairs, personal equipment movers (cyber mules), “segway-like” vehicles, etc. In accordance with the present invention, the mobile vehicle 102 also includes a charging module 302, an energy storage unit 304 and a receiver array 306 (See also FIG. 3). The mobile vehicle 102 will be described in more detail below with reference to FIGS. 3 and 8. It should be understood that the charging module 302 determines the position and direction of the mobile vehicle 102 and is able to send that information to other devices. The receiver array 306 is also able to couple with the transmitter array 110 to transfer energy that is stored in the energy storage unit 304 of the mobile vehicle 102. The charging module 302 is adapted for communication with the location sensors 104a, 104b, the energy transfer controller 106 and the global positioning system 108.

The one or more location sensors 104a, 104b are positioned proximate the roadway 112. As shown, the location sensor 104a may be integrated into other road side devices such as lighting, or the location sensor 104b may be an independent stand alone device. The location sensors 104a, 104b are coupled with wires or wirelessly to the energy transfer controller 106 as represented by the dashed line in FIG. 1. In one embodiment, the location sensors 104a, 104b are adapted and coupled for communication with the mobile vehicle 102 and merely receive speed, directory and trajectory information and send it to the energy transfer controller 106. In another embodiment, the location sensors 104a, 104b independently determine the speed, directory and trajectory of the mobile vehicle 102 and send it to the energy transfer controller 106.

The energy transfer controller 106 is coupled for communication with the mobile vehicle 102, the location sensors 104a, 104b, the global positioning system 108 and the transmitter array 110. The energy transfer controller 106 provides power to energize the transmitter array 110. The energy transfer controller 106 controls the activation and the resonance parameters of specific coils in the transmitter array 110. The energy transfer controller 106 calculates the trajectory and speed of the mobile vehicle 102, and determines which coils in the transmitter array 110 to active and when to activate them. The energy transfer controller 106 also controls the resonance parameters of the coils of the transmitter array 110 to achieve maximum energy transfer. The energy transfer controller 106 uses information such as location, direction, speed, vehicle type, resonance parameters of the coils of the receiver array 306 and other factors to determine when to active the transmitter array 110 and the resonance parameters. The energy transfer controller 106 is described in more detail below with reference to 9 and 10.

The global positioning system 108 is a conventional type and is represented by the satellite in FIG. 1. The global positioning system 108 includes transmitters in a plurality of satellites and a receiver to receive and triangulate a device's position from the satellite signals. The global positioning system 108 is adapted for communication with the mobile vehicle 102 and the energy transfer controller 106 to provide position information.

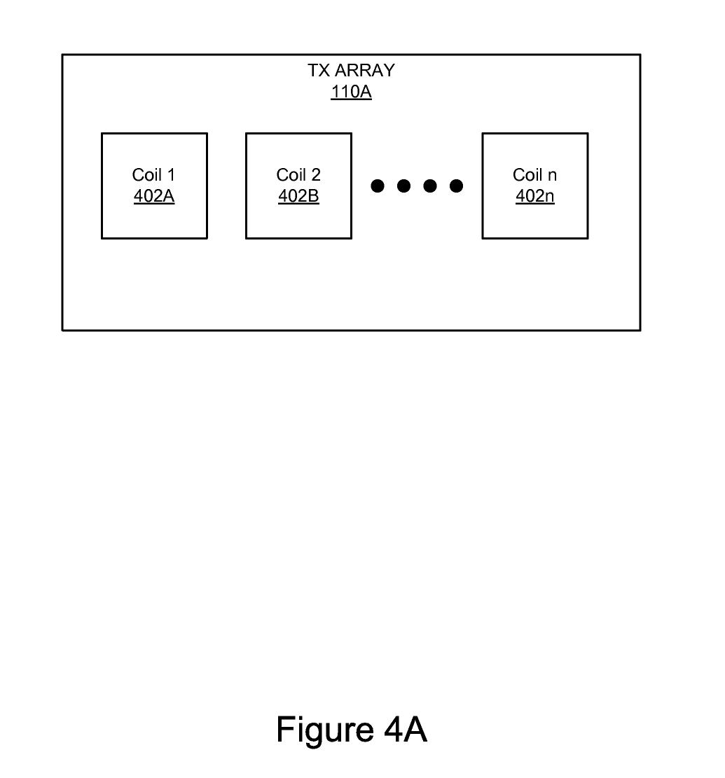

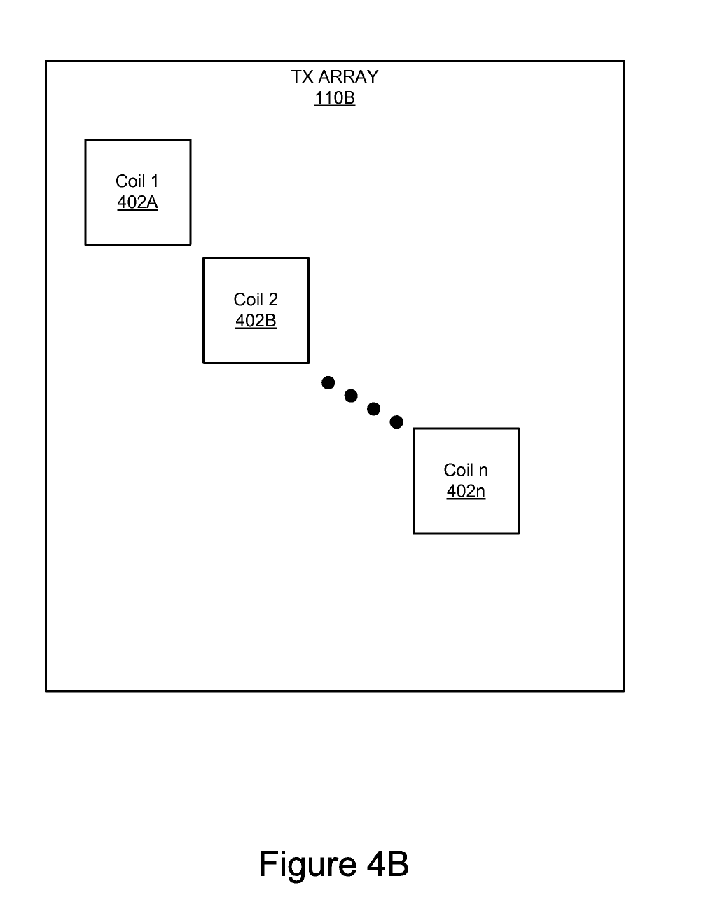

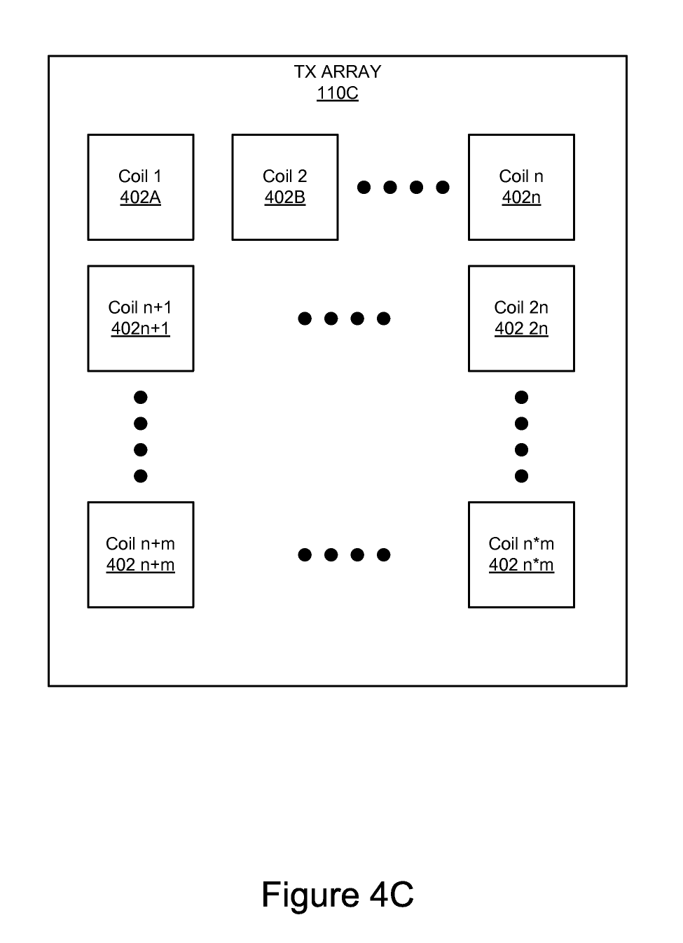

The transmitter array 110 includes a plurality of coils (See FIGS. 4-7). The transmitter array 110 is coupled to receive power from the energy transfer controller 106. The transmitter array 110 is also controlled by signals received from the energy transfer controller 106. The transmitter array 110 is described in more detail below with reference to FIGS. 4-7.

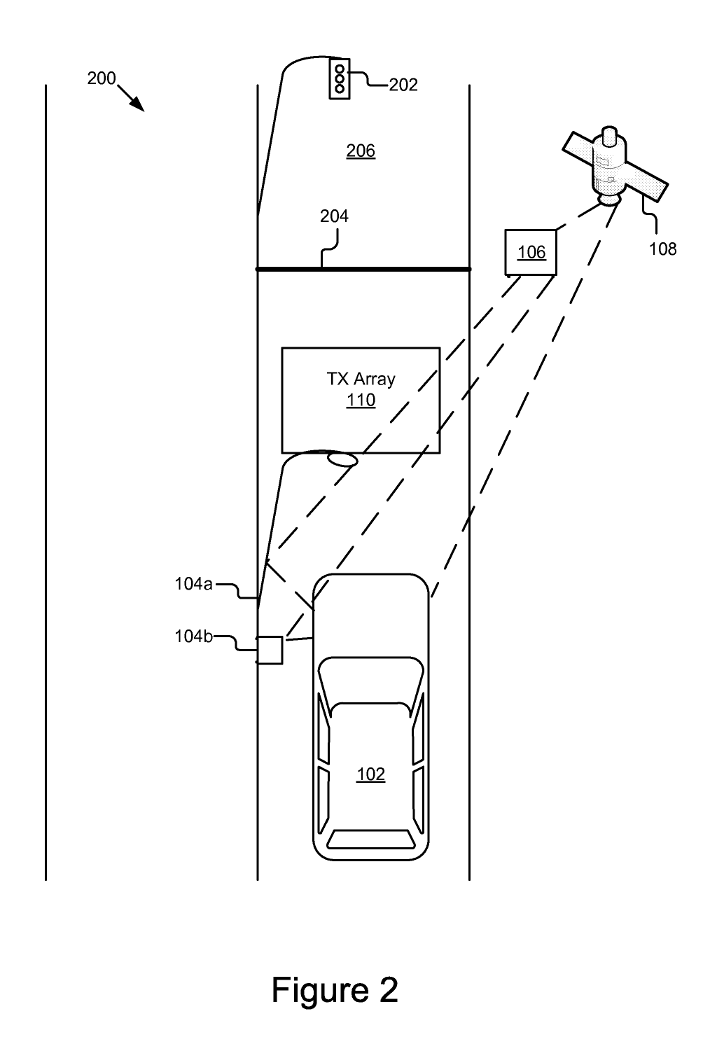

Referring now to FIG. 2, a second embodiment of the energy transfer system 200 is shown. This embodiment of the energy transfer system 200 includes the mobile vehicle 102, one or more location sensors 104a, 104b, an energy transfer controller 106, optionally a global positioning system 108 and the transmitter array 110. Like reference numerals have been used to represent components of the system 200 with the same or similar functionality as system 100.

In this embodiment, consistent with the principles of the present invention, the energy transfer system 200 is located just before a traffic light 202. A stop line 204 corresponding to the stop light 202 indicates where a vehicle moving past the traffic light 202 should stop. In accordance with the present invention, the transmitter array 110 is positioned in the roadway 206, beneath the surface and a predetermined distance before the stop line 204. For example, the transmitter array 110 is positioned a distance of between ten to fifty feet before the stop line 204. Thus, the speed of the mobile vehicle 102 is guaranteed to be reduced as it passes over the transmitter array 110. FIG. 2 also illustrates an alternate position for the location sensors 104a, 104b. In contrast to the locations in FIG. 1, the position of the location sensors 104a, 104b are on the same side of the roadway 106 but spaced apart along it. While the placement of the transmitter array 110 has been described as being in being before traffic lights, those skilled in the art will recognize that there are a variety of other locations where the speed of the mobile vehicle 102 is relatively slow such as in on ramps and off ramps, and that the transmitter array 110 may be positioned at such locations.

### Mobile Vehicle 102

Referring now to FIG. 3, one embodiment of the mobile vehicle 102 is shown. As noted above, the mobile vehicle 102 comprises a charging module 302, an energy storage unit 304 and a receiver array 306. In one embodiment, the mobile vehicle 102 is a conventional type of vehicle such as a fully electric vehicle or a hybrid electric vehicle augmented to include the charging module 302, the energy storage unit 304 and the receiver array 306 of the present invention.

The charging module 302 controls the operation of the receiver array 306 and transfers energy generated from the receiver array 306 to the energy storage unit 304. The charging module 302 also communicates information to the energy transfer controller 106 so it can optimize and maximize the amount of energy transferred from the transmitter array 110 to the receiver array 306. One embodiment for the charging module 302 is shown and described below with reference to FIG. 8. The charging module 302 is coupled by signal line 320 to receive energy generated by the receiver array 306. The charging module 302 is coupled by signal line 322 to send control signals to the receiver array 306, in particular, signal to specify one or more resonance parameters for coils of the receiver array 306. The charging module 302 is also coupled by signal line 324 to send energy to the energy storage unit 304.

The energy storage unit 304 is a conventional type and in one embodiment is a battery bank and associated electronics. In another embodiment, the energy storage unit 304 is the existing battery and associated electronics used with such a fully electric vehicle or a hybrid electric vehicle. The energy storage unit 304 is coupled to the charging module 302 by signal line 324 to received energy generated by the receiver array 306. In another embodiment (not shown), the energy storage unit 304 is coupled directly to the receiver array 306 to receive generated energy.

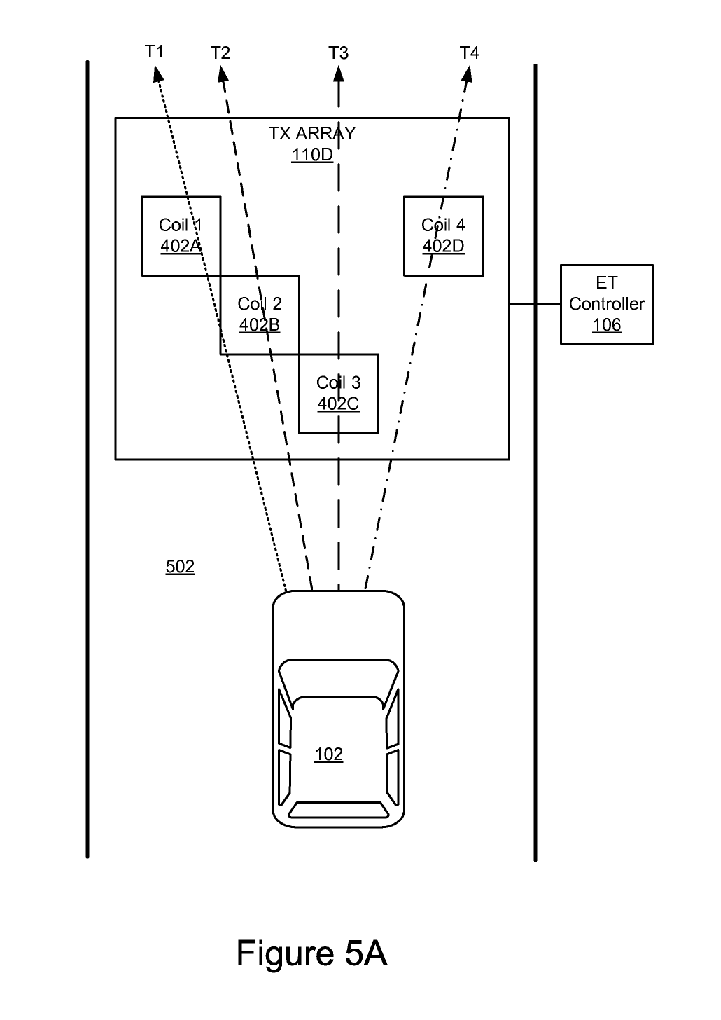

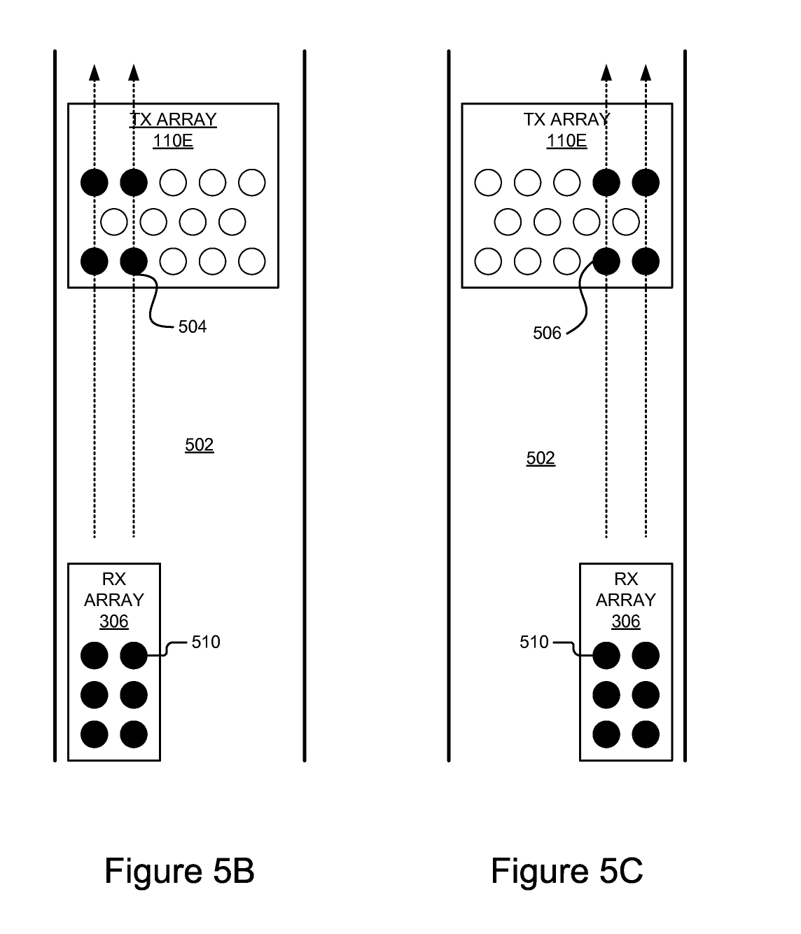

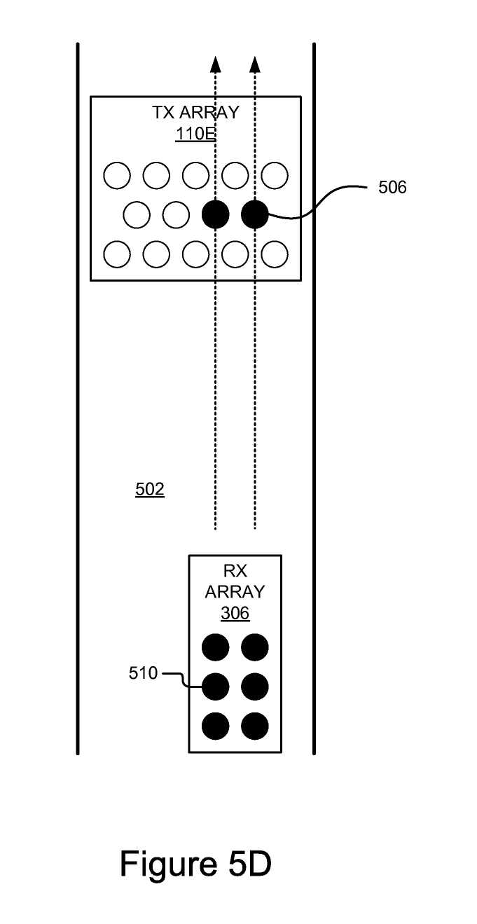

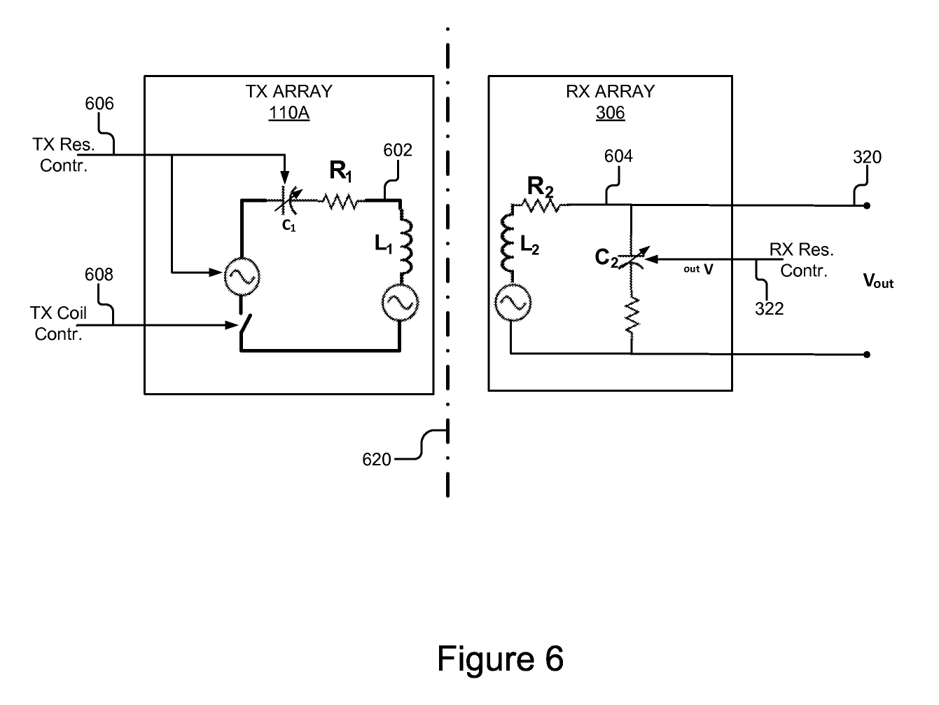

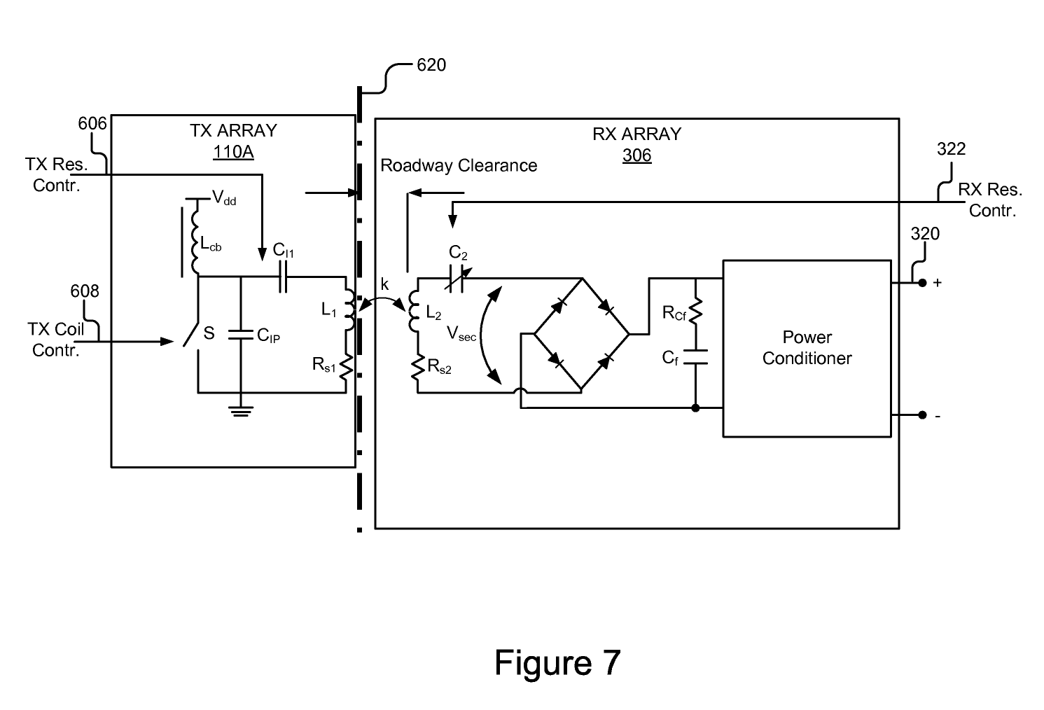

The receiver array 306 is a plurality of coils. The receiver array 306 is shown in more detail below with reference to FIG. 5. The receiver array 306 includes a plurality of coils that are tunable for optimum power transfer. In one embodiment, the resonance characteristics of the coils of the receiver array 306 are tuned to match those of corresponding coils of the transmitter array 100. Example embodiments of the coils of the receiver array 306 are shown and described in more detail below with reference to FIGS. 6 and 7. The receiver array 306 is coupled by signal line 320 to provide energy to the charging module 302 and by signal line 322 to receive control signals from the charging module 302.

### Transmitter Array 110

Referring now to FIGS. 4A-5D various embodiments of the transmitter array 110 will be described. Those skilled in the art will recognize that there are a variety of other configurations for the transmitter array 110, and that these are provided only by way of example. However, the transmitter array 110 has common attributes of: 1) having a plurality of coils; 2) the coils having different lateral positions across the roadway; and 3) each coil being tunable.

Referring now to FIG. 4A, a first embodiment of the transmitter array 110A is shown. FIG. 4A illustrates a top plan view of a very basic embodiment of transmitter array 110A. The transmitter array 110A includes a plurality of coils 402A-402n. The coils 402A-402n are spaced apart along a lateral axis of the transmitter array 110A. In this embodiment, the transmitter array 110A is preferably sized to be just less than the width of the roadway 112, 206. Thus, regardless of the position of the mobile vehicle 102 in the roadway 112, 206, there is at least one coil 402A-402n that is alignment with a corresponding coil (not shown) of the receiver array 306. Although not shown, each of the coils 402A-402n is coupled to the energy transfer controller 106 to receive signals to tune the coils 402A-402n. Further, in one embodiment, the coils 402A-402n are sized to match the receiver coils. For example, for efficient operation the coils 402A-402n are a minimum of 30″×30″ in width and length and coil winding 2″ high and the gap between the coil placement in the roadway and the receiver array 306 in the mobile vehicle 102 is in the range of 641 to 18″. The transmitter coil placement is best designed to maximize the flux density throughout the receiving coil. Placing the axis of the transmitter and receiver coils perpendicular to the surface of the roadway will direct high intensity flux densities into the receiving coil. This configuration guarantees that at least one coil is similar in size and carefully aligned for highest coupling coefficient k and highest efficiency of energy transfer. In this embodiment, as the mobile vehicle 102 passes over the transmitter array 110A, one or only a few coils 402A-402n that are in alignment with receiver coils are activated. This is particularly advantageous because energy is conserved while maximizing the energy transfer.

Referring now to FIG. 4B, a second embodiment of the transmitter array 110B is shown. FIG. 4B illustrates a top plan view of the transmitter array 110B. This second embodiment of the transmitter array 110B again includes a plurality of coils 402A-402n and the transmitter array 110B is preferably sized to be just less than the width of the roadway 112, 206. While the coils 402A-402n are spaced apart along a lateral axis of the transmitter array 110B, they are also spaced apart along the longitudinal axis of transmitter array 110B such that they are positioned on a diagonal from one corner of the transmitter array 110B to the other. This configuration on the transmitter array 110B is advantageous because it provides more flexibly for movement of the mobile vehicle 102 and the timing of activation of individual coils 402A-402n in the transmitter array 110B. This embodiment balances flexibility of arrangement with the overall cost of the transmitter array 110B.

Referring now to FIG. 4C, a third embodiment of the transmitter array 110C is shown. FIG. 4C illustrates a top plan view of the transmitter array 110C. This third embodiment of the transmitter array 110C again includes a plurality of coils 402A-402n*m and the transmitter array 110C is preferably sized to be just less than the width of the roadway 112, 206. In this embodiment, there are n by m coils 402A-402n*m arranged in a grid pattern. This embodiment is particularly advantageous because as the mobile vehicle 102 passes over the transmitter array 110C, multiple coils 402A-402n*m longitudinally are activated sequentially to provide a greater power transfer. For example, a series of coils such as coil 402b, 402n+2, 402 2n+2, etc. could be serially activated with each coil transferring energy to the receiver coils of the receiver array 306. While the example assumes the coils are aligned on a longitudinal axis of the transmitter array 110C, different columns of coils transmitter array 110C could be activated to correspond to the trajectory of the mobile vehicle 102 over the transmitter array 110C. It should be understood that in this embodiment each of the coils are tunable to match the resonance of the receiver coils on the receiver array 306

Referring now to FIG. 5A, a fourth embodiment of the transmitter array 110D is shown. FIG. 5A illustrates a top plan view of the transmitter array 110D, a roadway 502 and the mobile vehicle 102 traversing the roadway 502. This third embodiment of the transmitter array 110D again includes a plurality of coils 402A-402D and the transmitter array 110D is preferably sized to be just less than the width of the roadway 112, 206. In this embodiment, there are four coils 402A-402D arranged in a unique pattern to laterally cover width of the roadway 502. FIG. 5A illustrates a plurality of possible trajectories T1, T2, T3 and T4 that the mobile vehicle 102 might follow as it passes over the transmitter array 110D. As shown in FIG. 5A, depending on the trajectory of the mobile vehicle 102, only one coil is activated to transfer energy to the receiver array 306 (not shown). For example, if the mobile vehicle 102 follows trajectory T1, then coil 1 402A is activated at the appropriate time to transfer energy to the receiver array 306. Similarly, if the mobile vehicle 102 follows trajectory T2, then coil 2 402B is activated at the appropriate time to transfer energy to the receiver array 306. Likewise coils 3 402C and coil 4 402D are activated if the mobile vehicle 102 follows trajectory T3 and T4, respectively. FIG. 5A also illustrates the coupling of the energy transfer controller 106 to the transmitter array 110D to provide the resonance parameters for the coils 402A-402D.

Referring now to FIGS. 5B-5D, yet another embodiment of the transmitter array 110E is shown. FIGS. 5B-5D illustrate a top plan view of the transmitter array 110E, the roadway 502 and the receiver array 306 of the mobile vehicle 102 (not shown) traversing the roadway 502. In particular in FIGS. 5B-5D, the dashed lines show the trajectory of the receiver array 306 of the mobile vehicle 102 as it passes over the transmitter array 110E. In this embodiment, the transmitter array 110E includes rows of coils. Although only three rows of coils are shown, those skilled in the art will understand how this pattern could be continued to include any number of rows. The odd numbered rows (first and third rows) are aligned laterally with other odd number rows. Similarly, the even numbered row may be aligned with other even numbered rows. The even numbered row is slight offset in lateral alignment from the odd numbered rows of coils. This is advantageous because it ensures that there will be at least one coil that is n precise alignment with the coils of the receiver array 306.

As shown in FIG. 5B, the receiver array 306 (and thus the mobile vehicle 102) is positioned on the left side of the roadway 502. Thus as the receiver array 306 passes over the transmitter array 110E, the coils 510 of the receiver array 306 are in alignment with the coils 504 of the transmitter array 110E. The receiver array 306 includes 6 coils arranged in a 2×3 array. However, those skilled in the art will recognize that the receiver array 306 may include other configuration of multiple receive coils arranged from vehicle front to back in any size of array even one dimensional. The energy transfer controller 106 selectively activates these four coils 504 of the transmitter array 110E as the receiver array 306 move over the transmitter array 110E. Furthermore, as described in more detail below with reference to FIGS. 6 and 7, the resonance of the coils 504, 510 are tuned to match each other for maximum energy transfer.

As shown in FIG. 5C, the receiver array 306 is positioned on the right side of the roadway 502. In this case, as the receiver array 306 passes over the transmitter array 110E, the coils 510 of the receiver array 306 are in alignment with the coils 506 of the transmitter array 110E. The energy transfer controller 106 selectively activates these four coils 506 of the transmitter array 110E as the receiver array 306 move over the transmitter array 110E.

As shown in FIG. 5D, the receiver array 306 is positioned not quite to the right side of the roadway 502. In this case, as the receiver array 306 passes over the transmitter array 110E, the coils 510 of the receiver array 306 are in alignment with the coils 508 of the transmitter array 110E. The energy transfer controller 106 selectively activates these two coils 508 of the transmitter array 110E as the receiver array 306 move over the transmitter array 110E.

From the example embodiment shown in FIGS. 5B-5D, those skilled in the art will recognize that the use of multiple coils laterally and longitudinally allows for greater energy transfer, and selective activation of the most closely aligned coils allows energy conservation.

In one embodiment, the coil arrays are four turns of heavy gauge #00 copper wire 30″×30″ in size. For example, the coil width and length are at least five times the gap size. Small coil lengths and widths are used if small inter-coil gap is acceptable. Small coils and gap sizes allow one and two dimensional arrays of transmitter arrays 110 and receiver arrays 306. In another embodiment, superconducting wire is used as the coil wire to reduce the coil loss, but the critical current of superconductors must not exceed or efficiency will be lost. Low critical currents may limit power handling capacity of superconductor wires. Further, the frequencies of each coil are made equal and phases of individual transmitter coils are controlled so that external magnetic fields are additive. Currents in nearby wires must travel in same directions (i.e. a reversed directional polarity for every other coil).

In another embodiment, the coils 402 of the transmitter array 110 are approximately 2 times the size of the coils 510 of the receiver array 306. For example, the coils 402 of the transmitter array 110 are sized to be approximately 2M×2M and the coils 510 of the receiver array 306 are sized to be approximately 1M×1M. This particular advantageous because it large in the roadway coil 402 by 2 times increases the energy transfer time and reduces the steering tolerance requirements.

### Resonance Control

Referring now to FIG. 6, a coil L1 of the transmitter array 110 and a corresponding coil L2 of the receiver array 306 according to one embodiment of the present invention will be described. Those skilled in the art will recognize that FIG. 6 is used to illustrate only one coil L1 of the transmitter array 110 and the corresponding coil L2 the receiver array 306 for ease of understanding even though the arrays 110, 306 include several coils, one or more of which may be in a charging relationship at a given time. It should be understood that each coil L1 in the transmitter array 110 receives its own transmit coil control signal on line 608 and a transmit resonance control signal on line 606 from the energy transfer controller 106. This enables the energy transfer controller 106 selectively turn on and off the coil L1 as desired, and to tune it as needed for maximum energy transfer to the corresponding receiving coil L2. Similarly, each coil L2 in the receiver array 306 receives its own receive resonance control signal on line 322 from the charging module 302. Thus, the present invention allows both the transmitter array 110 and the receiver array 306 to be tuned to optimize the transfer energy for various conditions.

As shown in FIG. 6, the coil L1 has associated circuitry 602 including a variable capacitor C1, a resistor R1 and a power source 610 with an adjustable frequency. The present invention advantageously adjusts the resonance parameters, frequency and capacitance, so that the resonance coil coupling between the coils L1, L2 optimizes the energy transfer. In addition, the transmitter coil control signal on signal line 608 controls a switch so that the coil is only activated when the receiver array 306 is moving over the transmitter array 110. The receiver array 306 and the transmitter array 110 are separated by a gap and the road surface is represented by the dashed line 620. The coil L2 has associated circuitry 604 including a variable capacitor C2 and a resistor R2. In a similar manner, the associated circuitry 604 is coupled to receive the receiver resonance control signal on line 322. This signal varies the capacitance of C2 and allows the receiver array 306 to be tuned to match the transmitter array 110. The present invention advantageously uses the gap size, the frequency of power source 610, the amount of time that the receiver array 306 and the transmitter array 110 are in resonant coupling and the capacitance values to optimize the transfer of energy. Based on these factors, the energy transfer controller 106 and the charging module 302 generate transmitter coil control signal, the transmitter resonance control signal and receiver resonance control signal to providing precise values for C1 and C2 despite k values changing with mobile vehicle position relative to transmitter coil L1. Providing the resonating capacitors (capacitors shown above) in the primary and secondary coil circuits 602, 604 improve the transfer efficiency by providing compensating impedance caused by parasitic primary and secondary inductance. Varying the values of the capacitors C1 and C2 during energy transfer is used to optimize the resonance phenomena during the transfer and increase the average efficiency for the transfer. As can be seen, this configuration allows for dynamic variation of resonant coil system parameters and times for each specific energized coil crossing. More specifically, the resonating capacitance values are varied during transfer interval. The receiving circuit effective load resistance Vload/Iload is also varied during transfer interval. The location and duration of transfer interval varies with trajectory of mobile vehicle 102 over charging coils.

Referring now to FIG. 7, a second embodiment of the coil L1 of the transmitter array 110, the corresponding coil L2 of the receiver array 306 and their associated circuitry are shown. In this embodiment, the transmitter array 110 includes a power source Vdd and an addition inductor Lcb. The receiver array 306 includes a power conditioner and a bridge rectifier coupled as shown.

### Charging Module 302

Referring now to FIG. 8, one embodiment of the charging module 302 is described. The charging module 302 comprises a vehicle charging controller 802, a vehicle one authorization module 804, a location indication module 806, a vehicle to medication module 808, a processor and data storage 810, and an energy storage module 812.

The vehicle charging controller 802 receives information and generates a control signal that is output on signal line 322 to the receiver array 306. In particular, the vehicle charging controller 802 generates the receiver resonance control signal. This signal controls one or more operational parameters of the coil L2. In one embodiment, the vehicle charging controller 802 is a hardware controller with an output coupled to signal line 322 and an input coupled to receive information from the vehicle communication module 808 and the processor and data storage 810. In another embodiment, the vehicle charging controller 802 is software executable by the processor and data storage 810 that causes the processor to output the receiver resonance control signal. The vehicle charging controller 802 receives information such as the operating parameters of the transmitter array 110 so that the resonance parameters of the receiver coil L2 can be adjusted to maximize the transfer of energy from the transmitter array 110 to the receiver array 306. The circuit resonance parameters may by adjusted by varying the circuit capacitance, and inductor or the frequency of operation. Variable capacitance values may achieved by using electrically controlled semiconductor switches located in series with a bank of several low loss fixed value polypropylene, polystyrene or mica capacitors. Switching the capacitors is most efficiently performed when the voltage across them is nearly zero.

The vehicle authorization module 804 is software or routines executable by the processor 810 to provide authorization information. In one embodiment, the energy transfer system 100 is provided to each user at a cost. Prior to utilizing the system 100 for energy transfer, each user is required to set up an account, and once the account is set up, authorization information is provided to the user. This authorization information can then be transmitted by the mobile vehicle 102 along with a request for energy transfer from a given transmitter array 110 and energy transfer controller 106. Those skilled in the art will recognize that while not shown, the system 100 may include a server (not shown) coupled by a network (not shown) to any number of energy transfer controller's 106. The server is used to track use of the system, bill individual users for use, and collect other system and use information. The vehicle authorization module 804 is used to store authorization information particular to a specific user vehicle. The vehicle authorization module 804 is coupled to the vehicle communication module 808 to send the authorization information to the energy transfer controller 106.

The location indication module 806 is a device for determining the location of the mobile vehicle 102. In one embodiment, the location indication module 806 is a GPS receiver that can triangulate the location of the mobile vehicle 102 from satellite location signals. In another embodiment, the location indication module 806 determines location by triangulating off a plurality of cell tower signals. The location indication module 806 also outputs the location of the mobile vehicle 1022 to the vehicle communication module 808. In such a manner, the mobile vehicle 102 location is transmitted by the vehicle communication module 808 to the energy transfer controller 106 or to the location sensors 104.

The vehicle communication module 808 is a communication device for communication with other vehicles, the energy transfer controller 106 and other stationary or moving objects. In one embodiment, the vehicle communication module 808 is a WI-FI transceiver adapted to send packets of data using a TCP/IP format. In other embodiments, the vehicle communication module 808 is a satellite transceiver, a mobile communications transceiver, or an infrared transceiver. The vehicle communication module 808 is able to establish communication with the energy transfer controller 106 and send information relating to the energy transfer process. The vehicle communication module 808 is coupled to the vehicle charging controller 802, the vehicle authorization module 804, the location indication module 806, and the processor and data storage 810.

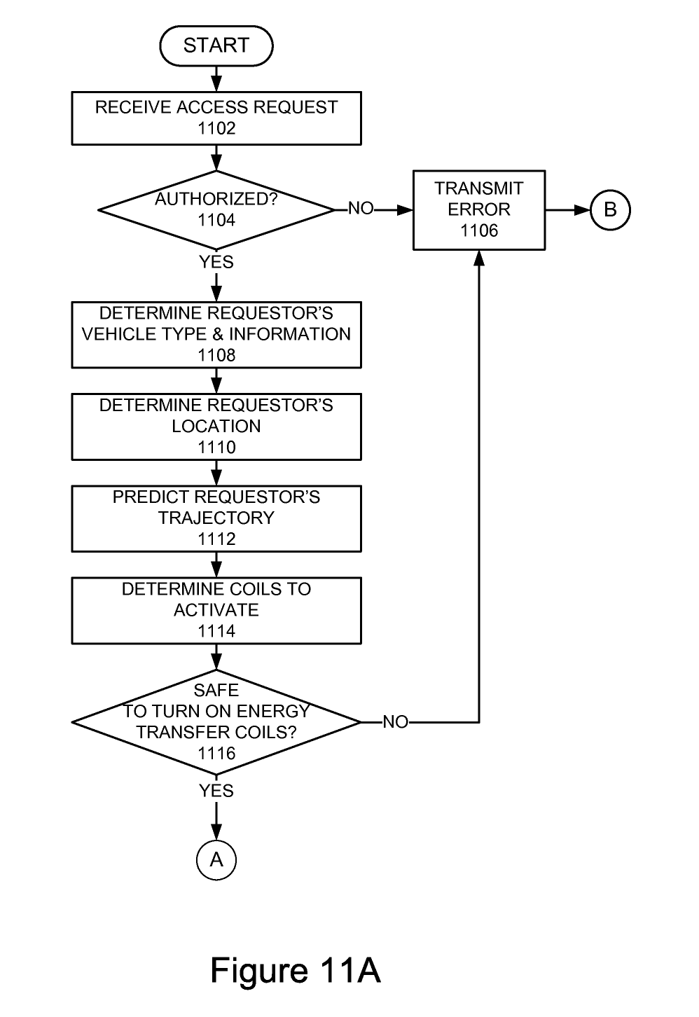

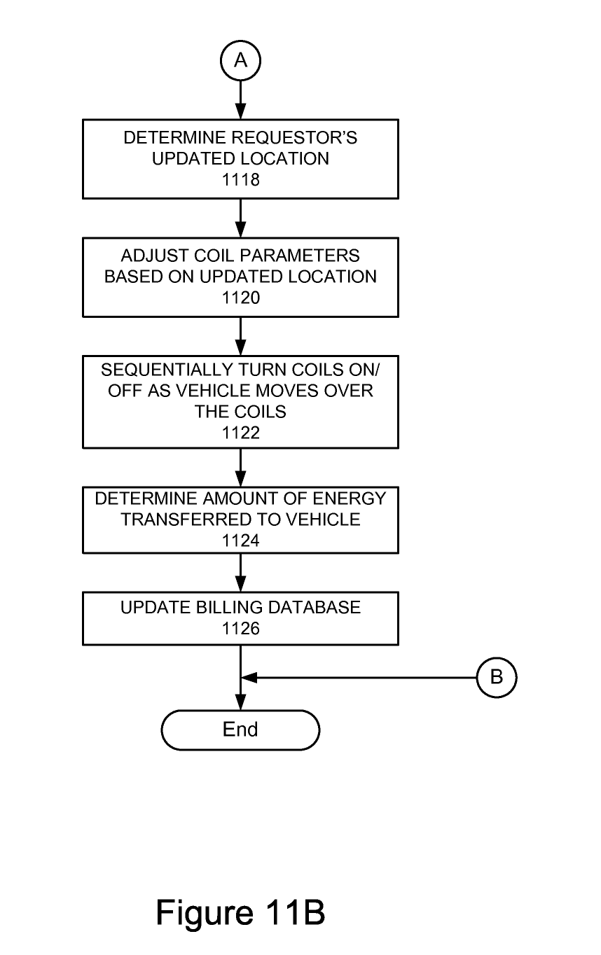

The processor and data storage 810 is a conventional type and is used to perform many of the operations described below with reference to FIGS. 11A and 11B related to the energy transfer between the transmitter array 110 and the receiver array 306. In one embodiment, the data storage 810 includes information such as vehicle type and distance of the receiver array 306. In certain embodiments, the processor and data storage 810 are used to execute the modules 802, 804, 806 and 808. The processor data storage 810 are also used to determine the resonance parameters sent to and output by the vehicle charging controller 802.

The energy storage module 812 has an input and an output and is adapted to transfer the generated energy from the receiver array 306 to the energy storage unit 304. The energy storage module 812 has an input coupled to signal line 320 to receive energy generated by the receiver array 306. In one embodiment, the energy storage module 812 includes power conditioning and outputs any received power via signal line 324 to the energy storage unit 304.

### Energy Transfer Controller 106

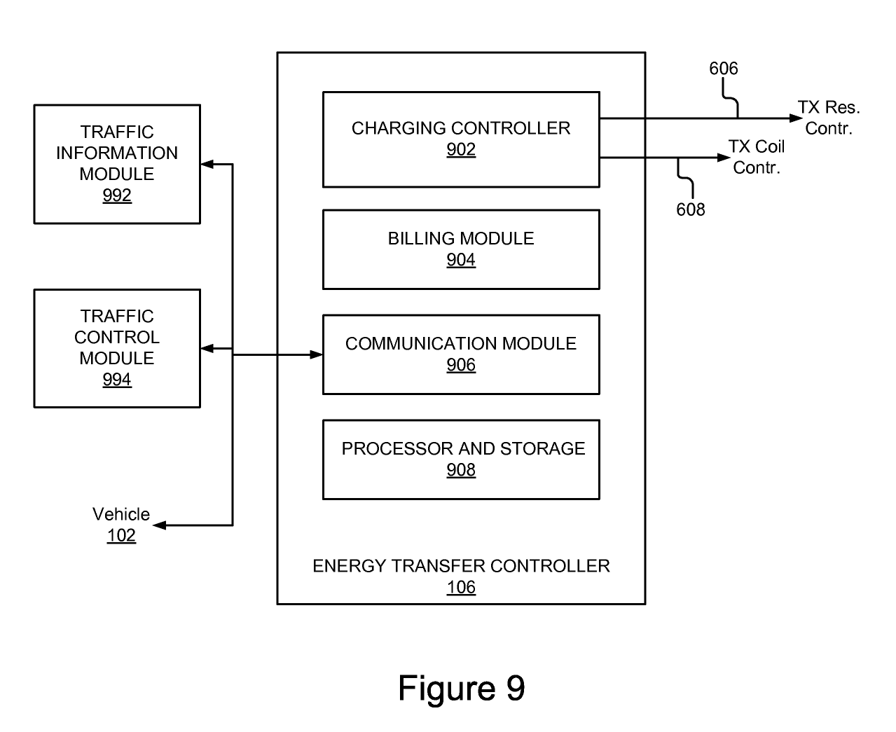

Referring now to FIG. 9, one embodiment of the energy transfer controller 106 is described. The energy transfer controller 106 comprises a charging controller 902, a billing module 904, a communication module 906, and a processor and storage 908. The energy transfer controller 106 is also coupled to receive information from the traffic information module 992, the traffic control module 994 and the mobile vehicle 102.

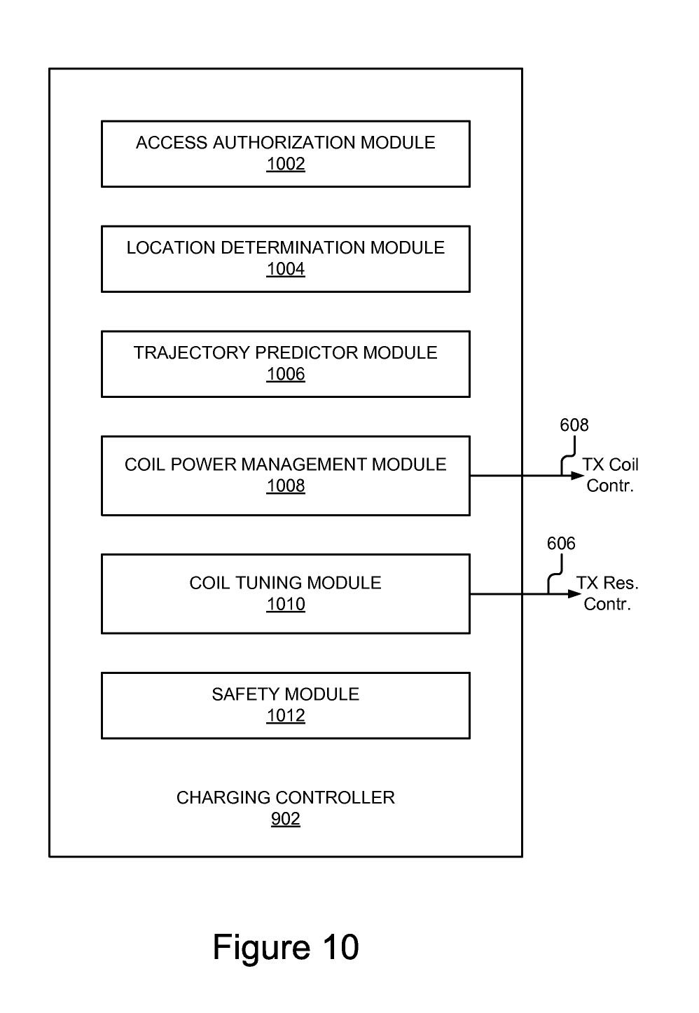

The charging controller 902 activates selected coils in the transmitter array 110 and sets the resonance parameters for the selected coils. One embodiment for the charging controller 902is a shown in more detail below with reference to FIG. 10. As shown in FIG. 9, the charging controller 902 has an output coupled to signal line 606 to provide the transmitter resonance control signal. This signal provides the parameters that control the resonance characteristics of a coil of the transmitter array 110. The charging controller 902 also has an output coupled to signal line 608 to provide the transmitter coil control signal. This signal controls when and which particular coil of the transmitter array 110 is turned on and off. The charging controller 902 is also coupled to receive information from the communication module 906, the billing module 904, and the processor and storage 908. Various different inputs are provided from these components 904, 906 and 908 that are used in determining when to activate a particular coil, which coils activate, and the resonance parameters used during activation of the coil.

The billing module 904 is software and routines executable by the processor 908. The billing module 904 is coupled to receive authorization information from the communication module 906. The billing module 904 receives authorization information, and in response sends a signal to the charging controller 902 indicating that for a particular mobile vehicle 102 activation of the transmitter array 110 is permitted. The billing module 904 also interacts with the charging controller 902 to determine the amount of energy that was transferred to the mobile device 102 and stores that information. In one embodiment, the billing module 904 includes the billing database (not shown) from which bills can be generated that reflect the amount of energy transferred to a particular mobile vehicle 102 during the past time period. As noted above, the billing module 904 is coupled to a server that generates a bill and sends it to a particular user associated with the authorization information. In alternate embodiment, the user has provided a credit card number or other billing information such as bank account and the fees for any energy transfer are automatically billed and debited using such billing information. The billing module 904 is coupled to the indication module 906 for interaction with third-party financial systems for billing and other processing.

The communication module 906 is a communication device similar to that described above has the vehicle communication module 808. The communication module 906 allows the energy transfer controller 106 to communicate with mobile vehicles 102, the traffic information module 992, the traffic control module 994 and other computing systems (not shown). In one embodiment, the communication module 906 is a WI-FI transceiver adapted to send packets of data using a TCP/IP format. In other embodiments, the communication module 906 is a satellite transceiver, a mobile communications transceiver, or an infrared transceiver. The communication module 906 is also coupled to provide information to the charging controller 902, the billing module 904, and the processor and storage 908.

The processor and storage 908 are of a conventional type, and are used to perform the operations of the energy transfer controller 106. The operation of the processor and storage 908 can be better understood with reference to FIGS. 11A and 11B below. The processor and storage 908 are coupled to the communication module 906, the billing module 904 and the charging controller 902. The processor storage 908 performs the routines of the present invention and the storage 908 stores information utilized by these other components.

The traffic information module 992 is another system that provides information on traffic conditions. The traffic information module 992 provides specific information related to the traffic conditions in general as well as traffic conditions near the energy transfer controller 106. For example, the real-time traffic information module 992 provides data similar to that publicly available in data system such as 511.org. The traffic information module 992 provides information such as normal traffic flow and rates, congested traffic rates and causes as well as other information that may impact the speed at which the mobile vehicle 102 passes by the energy transfer controller 106. This information is utilized by the processor and storage 908 to provide improved information as to when to activate and deactivate the transmitter array 110. The traffic information module 992 is adapted for communication with the communication module 906 of the energy transfer controller 106.

The traffic control module 994 is another system that provides information about specific traffic control mechanisms. Using the example described above with reference to FIG. 2, the traffic control module 994 sends information related to the status of the traffic light 202 to the energy transfer controller 106. This information is used by the charging controller 902 to determine specific times at which to activate and deactivate the transmitter array 110. For example, the traffic control module 994 signals to the energy transfer controller 106 when the traffic light 202 is going to transition from green to red. Knowing that the mobile vehicles 102 will be slowing down for the traffic light 202 allows the charging controller 902 to modify the activation/deactivation times and the resonance parameters according to future traffic conditions. The traffic control module 994 is adapted for communication with the charging controller 902 via the communication module 906 of the energy transfer controller 106.

Referring now to FIG. 10, the charging controller 902 of the energy transfer controller 106 is described in more detail. The charging controller 902 comprises an access authorization module 1002, a location determination module 1004, a trajectory predictor module 1006, a coil power management module 1008, a coil tuning module 1010, and a safety module 1012.

The access authorization module 1002 is coupled to receive authorization information from the mobile vehicle 102. The access authorization module 1002 is also coupled to the coil power management module 1008 to provide an authorization signal that enables the coil power management module 1008 to energize the transmitter array 110. In one embodiment, the access authorization module 1002 is software and routines executable by the processor 908. The authorization module 1002 includes a database of authorized users or is coupled to a server and network as described above to validate authorization information that is been received.

The location determination module 1004 is coupled by the communication module 906 to the location sensors 104A, 104B and the mobile vehicle 102. The location determination module 1004 receives information that can be used to compute the location of the mobile vehicle 102. In one embodiment, the location determination module 1004 receives real-time information from the mobile device 102 and this information is validated by location sensors 104A, 104B. In one embodiment, the location determination module 1004 generates location values for the mobile vehicle 102 and outputs them to the trajectory predictor module 1006.

The trajectory predictor module 1006 is coupled to the location determination module 1004. The trajectory predictor module 1006 receives the position information for the mobile vehicle 102 from the location determination module 1004. The trajectory predictor module 1006 uses the position information for the mobile vehicle 102 to determine a future path for the mobile vehicle 102. In particular, as shown described above with reference to FIG. 5, the trajectory predictor module 1006 determines which coils 402 of the transmitter array 110D that the mobile vehicle 102 will pass over, and the precise time at which the receiver array 306 will be within resonance coupling with the transmitter a 110D. The trajectory predictor module 1006 has an output coupled to the coil power management module 1008 to provide information about which coils 402 to activate and when to activate them.

The coil power management module 1008 is coupled to receive timing information from the trajectory predictor module 1006. The coil power management module 1008 controls when the coils 402 are activated and which coils 402 are activated. The power management module 1008 generates a transmitter coil control signal and outputs it to the transmitter array 110 on signal line 608. Although only a single signal line 608 is shown, those skilled in the art will recognize that the coil power management module 1008 can signal any one or more of the coils 402 of the transmitter array 110 to be active at a given point in time.

The coil tuning module 1010 is coupled to the communication module 906 and the processor and storage 908 to receive information about the mobile vehicle 102 and its receiver array 306. As has been noted above, the coils 402 of the transmitter array 110 are tuned to optimize the energy transfer to coils in the receiver array 306. The coil tuning module 1010 outputs a control signal on signal line 606 that is sent to the individual coils 402 of the transmitter array 110. In one embodiment, the coil tuning module 1010 modifies the field intensity and frequency at which the coils 402 resonate. For example, a frequency of 10 MHz can be used to operate the coils 402 of the transmitter array 110. In another embodiment, the coil tuning module 1010 adjusts the resident circuit transfer parameters such that the primary and secondary resonance capacitors reactance cancels out the parasitic inductance of the coils 402, 510. In yet another embodiment, the coil tuning module 1010 adjusts the frequency and capacitance of the transmitter circuitry 602 and the receiver circuitry 604 to optimize the energy transfer and adjusts the circuitry 602, 604 based upon the vehicle type and an estimated value of the gap between the coils L1 of the transmitter array 110 and the coils L2 of the receiver array 306.

The safety module 1012 is coupled to receive information from the trajectory predictor module 1006 and from other sensors (not shown) that detect the presence of humans or other object in proximity to the transmitter array 110. The safety module 1012 determines from these inputs whether there are objects in the proximity of the transmitter array 110 that may be harmed by activation of the transmitter array 110. If so, the safety module 1012 outputs a control signal to disable the coil power management module 1008 from activating any coils 402 in the transmitter array 110. The output of the safety module 1012 is coupled to the coil power management module 1008.

### Methods

Referring now to FIGS. 11A and 11B, the method for energy transfer according to one embodiment of the present invention is described. The process begins with the energy transfer controller 106 receiving 1102 an access request from a mobile vehicle 102. In one embodiment, the access request includes information about the type of mobile vehicle 102, authorization information and other information that affects the resonant coupling between the transmitter array 110 and the receiver array 306 of the mobile vehicle 102. In one embodiment, the access request is wirelessly transmitted by the mobile vehicle 102 to the energy transfer controller 106 as it approaches the energy transfer controller 106. Then the method determines 1104 whether the mobile device 102 is authorized to receive an energy transfer. If not, the method proceeds to step 1106 where the energy transfer controller 106 sends a message to the mobile device 102 indicating that it is not authorized. The mobile device 102 can present in response a message to the user indicating that charging is not authorized or the message may be completely ignored. After step 1106 the method is complete and ends.

On the other hand, if the mobile device 102 is found to be authorized in step 1104, the energy transfer controller 106 determines 1108 the requester's vehicle type and other information. This can be done using a wireless data interrogation or exchange between the energy transfer controller 106 and the charging module 302 of the mobile vehicle 102. For example, the mobile vehicle 102 may provide an identification of the type of vehicle which will provide the energy transfer controller 106 with an estimate of the gap distance between the transmitter array 110 and the receiver array 306. The communication between the mobile vehicle 102 may also provide information about the specific characteristics of the receiver array 306 and what attributes of the receiver array are tunable. This exchange of information can be used by both the charging controller 902 and the charging module 302 to optimize the energy transfer between the two arrays 110, 306. Next the energy transfer controller 106 determines 1110 the location of the mobile vehicle 102. As noted above, this location can either be calculated by the energy transfer controller 106 using input from the location sensors 104A, 104B or it can be provided by the mobile vehicle 102 such as by using a GPS system. Then the energy transfer controller 106 predicts 1112 the trajectory of the mobile vehicle 102. Based upon this trajectory and timing, the energy transfer controller 106 determines 1114 the coils 402 to activate. Next the method determines 1116 whether it is safe to turn on the energy transfer coils 402. Since the transfer coils 402 may have a high frequency and high power, they are disabled when humans or other life is in the vicinity of the transfer array 110 and maybe harmed by activation of the transfer array. If it is not safe to turn on the energy transfer coils, the method proceeds to step 1106 then transmits an error message. However, if it is safe to activate the energy transfer coils, the method continues by determining 1118 and updated location of the mobile vehicle 102. Then the coil parameters are adjusted 1120 based upon the updated location. Then the energy transfer controller 106 sequentially turns 1122 the coils on and off as the mobile vehicle 102 moves over the coils. Finally, the method determines 112 for the amount of energy transferred to the mobile vehicle 102, and updates 1126 the billing database.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. A system for transmitting electrical power to vehicles, the system comprising:
a transmitter array having a plurality of coils, the plurality of coils being arranged laterally across a roadway, each of the plurality of coils selectively operable and tunable;
an energy transfer controller coupled to the transmitter array and having a coil power management module and a trajectory predictor module, the trajectory predictor module determining a trajectory for a mobile vehicle and the coil power management module selectively activating one or more of the plurality of coils when a mobile vehicle is in resonance coupling with the one or more of the plurality of coils, the trajectory predictor module coupled to provide trajectory information to the coil power management module, and the coil power management module coupled to the plurality of coils.

2. The system of claim 1 wherein the transmitter array includes at least two columns of coils and at least two rows of coils.

3. The system of claim 1 wherein the energy transfer controller includes an access authorization module coupled to receive authorization information from the mobile vehicle, the access authorization module coupled to the coil power management module to provide an authorization signal that enables the coil power management module to energize the transmitter array when the received authorization information is validated.

4. The system of claim 1 wherein the energy transfer controller includes a location determination module for determining a location of the mobile vehicle, an output of the location determination module coupled to the trajectory predictor module to provide the location information.

5. The system of claim 4 further comprising a location sensor, the location sensor for detecting a position of a mobile vehicle, the location sensor coupled to the location determination module.

6. The system of claim 4 further comprising a communication module in communication with the mobile device to receive real-time location information from the mobile device, the communication module coupled to the location determination module to provide the real-time location information.

7. The system of claim 1 wherein the trajectory predictor module receives position information for the mobile vehicle, uses the position information for the mobile vehicle to determine a future path for the mobile vehicle including which of the plurality of coils of the transmitter array that the mobile vehicle will pass over, and a precise time at which a receiver array of the mobile device will be within resonance coupling with the transmitter array.

8. The system of claim 1 wherein the energy transfer controller includes a coil tuning module, the coil tuning module coupled to the plurality of coils of the transmitter array to provide a transmitter resonance control signal.

9. The system of claim 1 wherein the coil tuning module is coupled to a communication module to receive information about the mobile vehicle and its receiver array, and the coil tuning module modifies one from the group of field intensity, frequency, capacitance and inductance to optimize the energy transfer from the transmitter array.

10. The system of claim 1 wherein the coil tuning module adjusts resident circuit transfer parameters such that a primary and secondary resonance capacitors reactance cancels out a parasitic inductance of the plurality of coils of the transmitter array.

11. The system of claim 1 wherein the mobile vehicle includes a receiver array having a plurality of coils and the coils of receiver array are approximately half the area of the coils of the transmitter array.

12. The system of claim 11 wherein the plurality of coils of transmitter array are about 2 meters by 2 meters and the plurality of coils of receiver array are 1 meters by 1 meters.

13. The system of claim 1 comprising a safety module coupled to receive information from the trajectory predictor module and from another sensor that detects an object in proximity to the transmitter array, the safety module for disabling the coil power management module in response to detection of the object and a trajectory of the mobile vehicle over the transmitter array.

14. The system of claim 1 wherein the mobile vehicle includes a vehicle charging controller and a receiver array having a plurality of coils, the vehicle charging controller generating a receiver resonance control signal to control operational parameters of at least one of the plurality of coils.

15. The system of claim 14 wherein the receiver resonance control signal specifies a capacitance value for associated circuitry of at least one of the plurality of coils.

16. A method for transferring electrical power to vehicles, the method comprising:
receiving at an energy transfer controller an access request from a mobile vehicle;
predicting a trajectory for the mobile vehicle;
determining a coil of a transmitter array to activate based on the trajectory for the mobile vehicle;
adjusting coil parameters based on a location of the mobile vehicle; and
activating the coil as the mobile vehicle moves over the coil.

17. The method of claim 16 wherein the access request includes authorization information and the energy transfer controller determines whether the mobile vehicle is authorized to receive an energy transfer before activating the coil.

18. The method of claim 16 comprising determining a vehicle type of the mobile vehicle and other resonance parameters.

19. The method of claim 16 wherein predicting a trajectory for the mobile vehicle includes determining a location of the mobile device.

20. The method of claim 16 comprising:
determining whether it is safe to active the coil; and
wherein the step of activating the coil is performed only if it is safe to activate the coil.

21. The method of claim 16 wherein adjusting coil parameters includes modifying one from the group of frequency, capacitance, inductance, coil voltage amplitude, coil current amplitude and field intensity of associated circuitry for a coil of the transmitter array.

22. The method of claim 16 wherein the mobile vehicle includes a receiver array having a plurality of coils, and adjusting coil parameters includes modifying one from the group of frequency, capacitance, inductance, coil voltage amplitude, coil current amplitude and field intensity of associated circuitry for a coil of the receiver array.

23. The method of claim 16 wherein adjusting coil parameters includes adjusting resident circuit transfer parameters such that a primary and secondary resonance capacitors reactance cancels out a parasitic inductance of the plurality of coils of the transmitter array.

24. The method of claim 16 comprising
determines an amount of energy transferred to the mobile vehicle; and
updating a billing module with the amount of energy transferred.
